(19) United States
(12) Patent Application Publication
(10) Pub. No.: US 2023/0168227 A1
(43) Pub. Date: Jun. 1, 2023

(54) System And Method for Detecting Structural Damage to A Rigid Structure

(71) Applicant: ResoSense Ltd, Kfar Hess (IL)

(72) Inventors: Asaf BAR-DAVID, Kfar Hess (IL); Yuval SPECTOR, Bahan (IL)

(21) Appl. No.: 17/997,555

(22) PCT Filed: May 2, 2021
(86) PCT No.: PCT/IL2021/050500

§ 371 Date: Oct. 31, 2022

(30) Foreign Application Priority Data
May 3, 2020 (IL) 274413

(51) Int. Cl. G01N 29/04; G01M 5/00

(52) U.S. Cl. CPC G01N 29/045; G01M 5/0033; G01M 5/0066

(57) ABSTRACT

A system for detecting structural damage to a rigid structure, the system comprising: at least one impact generator capable of applying a one-time impact on the structure; an acoustic sensor; a vibration sensor; and a processing circuitry configured to: provide an indication of the structural damage to the rigid structure upon (a) a first deviation above a first threshold between an expected acoustic wave profile, expected to radiate from the structure, absent the structural damage, and an actual acoustic wave profile being measured by the acoustic sensor in response to an application of the one-time impact, or (b) a second deviation above a second threshold between an expected to vibration profile of expected vibrations of the structure, absent the structural damage, and an actual vibration profile in response to the application.

### TECHNICAL FIELD

The invention relates to a system and method for detecting structural damage to a rigid structure.

### BACKGROUND

Existing solutions for detecting structural damage to a rigid structure are costly, complicated and not continuously available. For example, an existing solution for detecting structural damage (e.g., fractures, cracks, etc.) to a rigid structure is to perform X-ray imaging of the rigid structure.

There is thus a need for a new system and method for detecting structural damage to a rigid structure.

References considered to be relevant as background to the presently disclosed subject matter are listed below. Acknowledgement of the references herein is not to be inferred as meaning that these are in any way relevant to the patentability of the presently disclosed subject matter.

U.S. Patent Application Publication No. 2010/0050308, published on Mar. 4, 2010, describes an insert for use in clothing designed to protect against bullets or knife attacks including an upper layer having a ceramic matrix. A pair of plugs are fitted to the ceramic layer, the plugs being made from a material having an impedance to vibration substantially the same as that of the ceramic matrix at the point of manufacture. The plugs are configured for conducting mechanical vibration through the ceramic layer, for recording a vibration-related signature for the insert. By comparing a series of such signatures recorded over time, it is possible to assess whether the internal structure of the ceramic matrix has become damaged, which is useful in determining whether the insert needs to be replaced or repaired.

U.S. Patent Application Publication No. 2017/0167927, published on Jun. 15, 2017, describes an armor plate damage detection and testing system that uses an initial electrical signal to generate mechanical energy waves that travel across the armor plate and reflect off the plate surfaces, wherein the reflections of those waves are recorded and analyzed with reference to a previously stored wave reflection signature to determine if damage has occurred to the armor plate. The analyzed results are communicated to the user in real time using a display unit and can further be communicated to a remote entity through an incorporated wireless transmitter.

### GENERAL DESCRIPTION

In accordance with a first aspect of the presently disclosed subject matter, there is provided a system for detecting structural damage to a rigid structure, the system comprising: at least one impact generator capable of applying a one-time impact on the rigid structure, thereby causing the rigid structure to vibrate; an acoustic sensor configured to measure acoustic waves radiated from the rigid structure; a vibration sensor configured to measure vibrations of the rigid structure; and a processing circuitry configured to: obtain information defining (a) an expected acoustic wave profile of expected acoustic waves expected to radiate from the rigid structure, absent the structural damage to the rigid structure, in response to an application, by the impact generator, of the one-time impact on the rigid structure, and (b) an expected vibration profile of expected vibrations of the rigid structure, absent the structural damage to the rigid structure, in response to the application; obtain actual acoustic waves radiating from the rigid structure, in response to the application, the actual acoustic waves being measured by the acoustic sensor; generate an actual acoustic wave profile based on the actual acoustic waves; obtain actual vibrations of the rigid structure, in response to the application, the actual vibrations being measured by the vibration sensor; generate an actual vibration profile based on the actual vibrations; compare (a) the expected acoustic wave profile with the actual acoustic wave profile and (b) the expected vibration profile with the actual vibration profile; and provide a user of the system with an indication of the structural damage to the rigid structure upon the compare indicating at least one of: (a) a first deviation above a first threshold between the expected acoustic wave profile and the actual acoustic wave profile or (b) a second deviation above a second threshold between the expected vibration profile and the actual vibration profile.

In some cases, the one-time impact is applied by the impact generator on the rigid structure indirectly.

In some cases, the impact generator has a known momentum upon the application of the one-time impact.

In some cases, the rigid structure is suspended in the air by a mechanical connection that is connected to the rigid structure upon the application of the one-time impact.

In some cases, the rigid structure is a ceramic plate.

In some cases, the ceramic plate includes one or more first layers made of polymeric material and one or more second layers made of ceramic material, wherein at least one given first layer of the first layers and an adjacent second layer of the second layers, adjacent to the given first layer, are affixed to each other.

In some cases, the structural damage is one or more of: a crack in one or more of the second layers, a fracture in one or more of the second layers, or a separation between the given first layer and the adjacent second layer.

In some cases, the expected acoustic waves are previously measured acoustic waves that were radiated from the rigid structure, in response to a first earlier application, by the impact generator, of the one-time impact on the rigid structure, absent the structural damage to the rigid structure.

In some cases, the expected vibrations are previously measured vibrations of the rigid structure, in response to a second earlier application, by the impact generator, of the one-time impact on the rigid structure, absent the structural damage to the rigid structure.

In some cases, the actual acoustic waves and the actual vibrations are measured simultaneously.

In some cases, the actual acoustic waves are measured within a frequency range of 0-2,500 KHz.

In some cases, the actual vibrations are measured within a frequency range of 20-20,000 KHz.

In some cases, the impact generator includes a spring-loaded mechanical element, and wherein the one-time impact is applied by pulling the mechanical element.

In some cases, the acoustic sensor, the vibration sensor and the processing circuitry are activated in response to the pulling of the mechanical element.

In accordance with a second aspect of the presently disclosed subject matter, there is provided a method for detecting structural damage to a rigid structure, the method comprising: obtaining information defining an expected acoustic wave profile of expected acoustic waves expected to radiate from the rigid structure, absent the structural damage to the rigid structure, in response to an application, by an impact generator, of a one-time impact on the rigid structure that causes the rigid structure to vibrate; obtaining information defining an expected vibration profile of expected vibrations of the rigid structure, absent the structural damage to the rigid structure, in response to the application; obtaining actual acoustic waves radiating from the rigid structure, in response to the application, the actual acoustic waves being measured by an acoustic sensor; generating an actual acoustic wave profile based on the actual acoustic waves; obtaining actual vibrations of the rigid structure, in response to the application, the actual vibrations being measured by a vibration sensor; generating an actual vibration profile based on the actual vibrations; comparing (a) the expected acoustic wave profile with the actual acoustic wave profile and (b) the expected vibration profile with the actual vibration profile; and providing an indication of the structural damage to the rigid structure upon the comparing indicating at least one of: (a) a first deviation above a first threshold between the expected acoustic wave profile and the actual acoustic wave profile or (b) a second deviation above a second threshold between the expected vibration profile and the actual vibration profile.

In some cases, the one-time impact is applied by the impact generator on the rigid structure indirectly.

In some cases, the impact generator has a known momentum upon the application of the one-time impact.

In some cases, the rigid structure is suspended in the air by a mechanical connection that is connected to the rigid structure upon the application of the one-time impact.

In some cases, the rigid structure is a ceramic plate.

In some cases, the ceramic plate includes one or more first layers made of polymeric material and one or more second layers made of ceramic material, wherein at least one given first layer of the first layers and an adjacent second layer of the second layers, adjacent to the given first layer, are affixed to each other.

In some cases, the structural damage is one or more of: a crack in one or more of the second layers, a fracture in one or more of the second layers, or a separation between the given first layer and the adjacent second layer.

In some cases, the expected acoustic waves are previously measured acoustic waves that were radiated from the rigid structure, in response to a first earlier application, by the impact generator, of the one-time impact on the rigid structure, absent the structural damage to the rigid structure.

In some cases, the expected vibrations are previously measured vibrations of the rigid structure, in response to a second earlier application, by the impact generator, of the one-time impact on the rigid structure, absent the structural damage to the rigid structure.

In some cases, the actual acoustic waves and the actual vibrations are measured simultaneously.

In some cases, the actual acoustic waves are measured within a frequency range of 0-2,500 KHz.

In some cases, the actual vibrations are measured within a frequency range of 20-20,000 KHz.

In some cases, the impact generator includes a spring-loaded mechanical element, and wherein the one-time impact is applied by pulling the mechanical element.

In some cases, the acoustic sensor, the vibration sensor and the processing circuitry are activated in response to the pulling of the mechanical element.

In accordance with a third aspect of the presently disclosed subject matter, there is provided a non-transitory computer readable storage medium having computer readable program code embodied therewith, the computer readable program code, executable by a processing circuitry of a computer to perform a method for detecting structural damage to a rigid structure, the method comprising: obtaining information defining an expected acoustic wave profile of expected acoustic waves expected to radiate from the rigid structure, absent the structural damage to the rigid structure, in response to an application, by an impact generator, of a one-time impact on the rigid structure that causes the rigid structure to vibrate; obtaining information defining an expected vibration profile of expected vibrations of the rigid structure, absent the structural damage to the rigid structure, in response to the application; obtaining actual acoustic waves radiating from the rigid structure, in response to the application, the actual acoustic waves being measured by an acoustic sensor; generating an actual acoustic wave profile based on the actual acoustic waves; obtaining actual vibrations of the rigid structure, in response to the application, the actual vibrations being measured by a vibration sensor; generating an actual vibration profile based on the actual vibrations; comparing (a) the expected acoustic wave profile with the actual acoustic wave profile and (b) the expected vibration profile with the actual vibration profile; and providing an indication of the structural damage to the rigid structure upon the comparing indicating at least one of: (a) a first deviation above a first threshold between the expected acoustic wave profile and the actual acoustic wave profile or (b) a second deviation above a second threshold between the expected vibration profile and the actual vibration profile.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram schematically illustrating one example of a system for detecting structural damage to a rigid structure, in accordance with the presently disclosed subject matter;

FIG. 2 is an illustration of one example of a product that includes one or more components of the system, in accordance with the presently disclosed subject matter;

FIG. 3 is an illustration of one example of the product clamped to the rigid structure, in accordance with the presently disclosed subject matter

FIG. 4 is a flowchart illustrating one example of a sequence of operations for detecting structural damage to the rigid structure, in accordance with the presently disclosed subject matter;

FIG. 5 provides a first graph illustrating an example of a first acoustic wave profile of an undamaged rigid structure, and a second graph illustrating an example of a second acoustic wave profile of a structurally damaged rigid structure, in accordance with the presently disclosed subject matter; and

FIG. 6 provides a third graph illustrating an example of a first vibration profile of an undamaged rigid structure, and a fourth graph illustrating an example of a second vibration profile of a structurally damaged rigid structure, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “identifying”, “applying”, “measuring”, “obtaining”, “generating”, “comparing”, “providing”, “activating”, “pulling” or the like, include actions and/or processes, including, inter alia, actions and/or processes of a computer, that manipulate and/or transform data into other data, said data represented as physical quantities, e.g. such as electronic quantities, and/or said data representing the physical objects. The terms “computer”, “processor”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

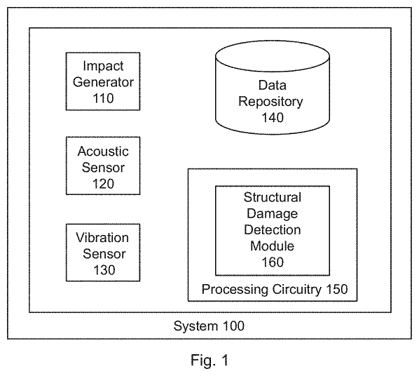

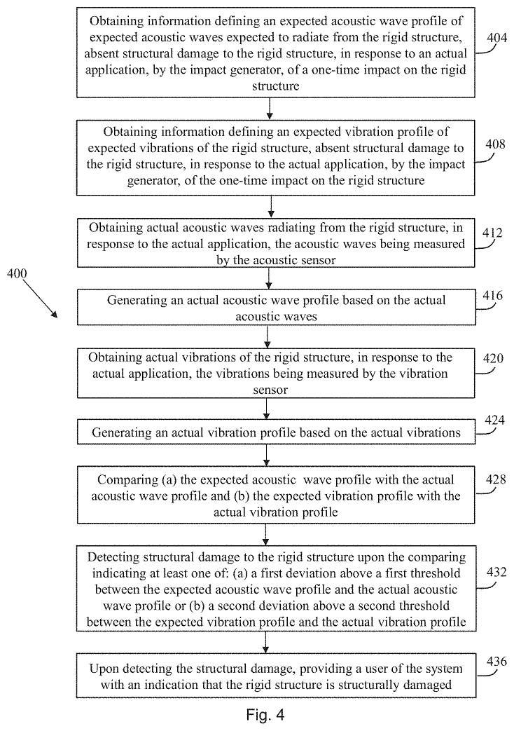

In embodiments of the presently disclosed subject matter, fewer, more and/or different stages than those shown in FIG. 4 may be executed. In embodiments of the presently disclosed subject matter, one or more stages illustrated in FIG. 4 may be executed in a different order and/or one or more groups of stages may be executed simultaneously. FIGS. 1 to 3 illustrate a general schematic of the system architecture in accordance with embodiments of the presently disclosed subject matter. Each module in FIG. 1 can be made up of any combination of software, hardware and/or firmware that performs the functions as defined and explained herein. The modules in FIG. 1 may be centralized in one location or dispersed over more than one location. In other embodiments of the presently disclosed subject matter, the system may comprise fewer, more, and/or different modules than those shown in FIG. 1.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a block diagram schematically illustrating one example of a system 100 for detecting structural damage to a rigid structure, in accordance with the presently disclosed subject matter.

In accordance with the presently disclosed subject matter, system 100 is configured to include at least one impact generator 110, at least one acoustic sensor 120, and at least one vibration sensor 130. Impact generator 110 is capable of applying a one-time impact on the rigid structure. Application of the one-time impact on the rigid structure by the at least one impact generator 110 causes the rigid structure to vibrate.

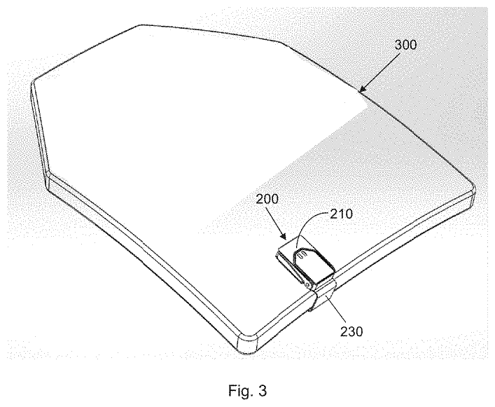

In some cases, the one-time impact can be applied on the rigid structure while the rigid structure is suspended in air, e.g. by a mechanical connection that is connected to the rigid structure. Alternatively, in some cases (non-limiting), the one-time impact can be applied on the rigid structure while the rigid structure is positioned face-down or face-up (e.g., as illustrated in FIG. 3) or on its side.

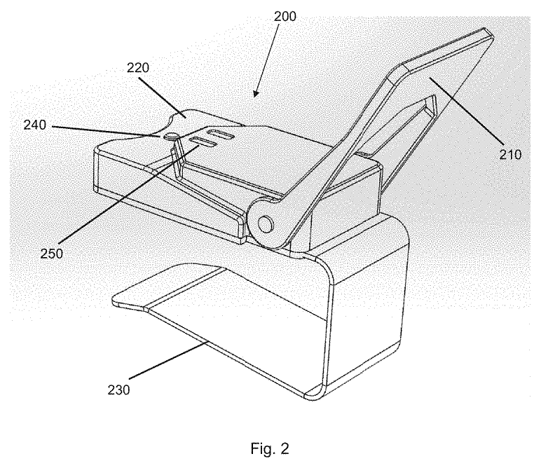

In some cases, the one-time impact can be applied by impact generator 110 on the rigid structure indirectly, as detailed further herein, inter alia with reference to FIG. 2.

Acoustic sensor 120 (e.g., a microphone) can be configured to measure acoustic waves radiating from the rigid structure, in response to the application of the one-time impact on the rigid structure by the impact generator 110.

Vibration sensor 130 (e.g., an accelerometer) can be configured to measure vibrations of the rigid structure, in response to the application of the one-time impact on the rigid structure by the impact generator 110.

System 100 can comprise or otherwise be associated with a data repository 140 (e.g., a database, a storage system, a memory including Read Only Memory—ROM, Random Access Memory—RAM, and/or any other type of memory, etc.) configured to store data, including, inter alia, information defining an expected acoustic wave profile and information defining an expected vibration profile. In some cases, data repository 140 can be further configured to enable retrieval and/or update and/or deletion of the stored data. It is to be noted that in some cases, data repository 140 can be distributed.

System 100 can be configured to include a processing circuitry 150. Processing circuitry 150 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data, including data for detecting structural damage to the rigid structure.

Processing circuitry 150 can be configured to include a structural damage detection module 160. Structural damage detection module 160 can be configured to detect structural damage to the rigid structure, as detailed further herein, inter alia with reference to FIG. 4.

In some cases, the rigid structure can be a ceramic plate. In some cases, the ceramic plate can include one or more first layers made of polymeric material and one or more second layers made of ceramic material, wherein at least one given first layer of the first layers and an adjacent second layer of the second layers, adjacent to the given first layer, are affixed to each other.

In some cases, the structural damage to the ceramic plate can be one or more of: a crack in one or more of the second layers, a fracture in one or more of the second layers, or a separation between the given first layer and the adjacent second layer.

Attention is now drawn to FIG. 2, an illustration of one example of a product 200 that includes one or more components of the system 100, in accordance with the presently disclosed subject matter. In accordance with the presently disclosed subject matter, in some cases, product 200 can be configured to include an impact generator 110 having a spring-loaded mechanical element (e.g., latch or knob) 210 and an impact hit surface 220.

In some cases, product 200 can be configured to include a latch 230, e.g. a U-shaped latch, as illustrated in FIG. 2. Latch 230 can be configured to clamp the product 200 on the rigid structure 300, e.g. as illustrated in FIG. 3, wherein the product 200 is clamped on the rigid structure 300 when the one-time impact is applied to the rigid structure 300.

Prior to the application of the one-time impact to the rigid structure 300, spring-loaded mechanical element 210 can be configured to overlay the impact hit surface 220.

In some cases, the one-time impact can be applied on the rigid structure 300 indirectly by raising (e.g., by pulling) the spring-loaded mechanical element 210 from the impact hit surface 220, as illustrated in FIG. 2, and then enabling the spring-loaded mechanical element 210 to drop and impact the impact hit surface 220 (e.g., by releasing the spring-loaded mechanical element 210). Upon impacting the impact hit surface 220, spring-loaded mechanical element 210 overlays the impact hit surface 220, as illustrated in FIG. 3.

In some cases, product 200 can be configured to include the acoustic sensor 120 and the vibration sensor 130. Additionally, in some cases, product 200 can be configured to include at least some of the processing circuitry 150.

In some cases, product 200 can be further configured to include an activation switch 240. Upon raising the spring-loaded mechanical element 210 from the impact hit surface 220 to apply the one-time impact, activation switch 240 is released, thereby activating components of the system 100 (e.g., acoustic sensor 120, vibration sensor 130. at least some of the processing circuitry 150).

In some cases, product 200 can be configured to provide a user of the system 100 (and the product 200) with an indication of whether the rigid structure is structurally damaged or undamaged. In some cases, the indication can be provided by a light emitting diode (LED). For example, in some cases, product 200 can be configured to include two indication LEDs 250 that emit light of different colors (e.g. one indication LED emits red light and the other indication LED emits green light). If the rigid structure is structurally damaged, one of the indication LEDs 250 emits light (e.g., the indication LED that emits red light). On the other hand, if the rigid structure is not structurally damaged, the other of the indication LEDs 250 emits light (e.g., the indication LED that emits green light),

Attention is now drawn to FIG. 4, a flowchart illustrating one example of a sequence of operations 400 for detecting structural damage to the rigid structure 300, in accordance with the presently disclosed subject matter.

In accordance with the presently disclosed subject matter, processing circuitry 150 can be configured, e.g. using structural damage detection module 160. to obtain information defining an expected acoustic wave profile of expected acoustic waves expected to radiate from the rigid structure 300, absent structural damage to the rigid structure 300, in response to an actual application, by impact generator 110, of a one-time impact on the rigid structure 300 (block 404).

Processing circuitry 150 can also be configured, e.g. using structural damage detection module 160, to obtain information defining an expected vibration profile of expected vibrations of the rigid structure 300, absent structural damage to the rigid structure 300, in response to the actual application, by impact generator 110, of the one-time impact on the rigid structure 300 (block 408).

In some cases, the expected acoustic waves in the expected acoustic wave profile can be previously measured acoustic waves that were radiated from the rigid structure 300, in response to a first earlier application, by impact generator 110, of the one-time impact on the rigid structure 300, absent structural damage to the rigid structure 300, the first earlier application being applied prior to the actual application. In some cases, the first earlier application of the one-time impact can occur during product testing of the rigid structure 300.

In some cases, the expected acoustic wave profile can be obtained by processing circuitry 150 not based on previously measured acoustic waves. For example, a manufacturer of the rigid structure 300 can provide the expected acoustic wave profile, e.g. based on measured acoustic waves of other rigid structures tested by the manufacturer.

In some cases, the expected vibrations in the expected vibration profile can be previously measured vibrations of the rigid structure 300, in response to a second earlier application, by impact generator 110, of the one-time impact on the rigid structure 300, absent structural damage to the rigid structure 300, the second earlier application being applied prior to the actual application. In some cases, the first earlier application and the second earlier application can be the same. In some cases, the second earlier application of the one-time impact can occur during product testing of the rigid structure 300.

In some cases, the expected vibration profile can be obtained by processing circuitry 150 not based on previously measured vibrations. For example, a manufacturer of the rigid structure 300 can provide the expected vibration profile, e.g. based on measured vibrations of other rigid structures tested by the manufacturer.

The actual application of the one-time impact on the rigid structure 300 can be applied in the same manner as the first earlier application of the one-time impact, if applied, and as the second earlier application of the one-time impact, if applied, e.g. by using product 200 in each of the applications of the one-time impact. In this manner, the impact generator can have a known momentum upon each application of the one-time impact.

Processing circuitry 150 can be configured, e.g. using structural damage detection module 160, to obtain actual acoustic waves radiating from the rigid structure 300, in response to the actual application of the one-time impact, the actual acoustic waves being measured by the acoustic sensor 120 (block 412).

Furthermore, processing circuitry 150 can be configured, e.g. using structural damage detection module 160, to generate an actual acoustic wave profile based on the actual acoustic waves (block 416).

Processing circuitry 150 can be configured, e.g. using structural damage detection module 160, to obtain actual vibrations of the rigid structure 300, in response to the actual application of the one-time impact, the actual vibrations being measured by the vibration sensor 130 (block 420).

Furthermore, processing circuitry 150 can be configured, e.g. using structural damage detection module 160, to generate an actual vibration profile based on the actual vibrations (block 424).

In some cases, in which the rigid structure 300 is a ceramic plate, the expected acoustic waves and the actual acoustic waves that are radiated from the ceramic plate can be within a frequency range of 0-2,500 KHz. Additionally, in some cases, the expected vibrations and the actual vibrations of the ceramic plate can be within a frequency range of 20-20,000 KHz.

In some cases, the actual acoustic waves and the actual vibrations are measured simultaneously.

Processing circuitry 150 can be configured, e.g. using structural damage detection module 160, to compare (a) the expected acoustic wave profile with the actual acoustic wave profile and (b) the expected vibration profile with the actual vibration profile (block 428).

In some cases, the comparison between at least one of: (a) the expected acoustic wave profile with the actual acoustic wave profile, and (b) the expected vibration profile with the actual vibration profile can be associated with the impact event, being the application of the one-time impact on the rigid structure 300. In some cases, the expected profiles (acoustic wave vibration/acoustic wave & vibration) can be compared to the corresponding actual profiles (acoustic wave/vibration/acoustic wave & vibration) during a first time period following the impact event, wherein, in response to the impact event, processing circuitry 150 obtains for the first time, an actual wakeup amplitude value that exceeds a pre-defined wakeup amplitude value. In some cases, the first time period can begin at the time that the processing circuitry 150 obtains the actual wakeup amplitude value. Moreover, in some cases, the first time period can end approximately 0.02 seconds after processing circuitry 150 obtains the actual wakeup amplitude value. The comparison between a respective expected profile and its corresponding actual profile can be at least one of: (A) a comparison of a sum of the absolute values of the amplitudes of the collected data (i.e., acoustic waves, vibrations) during the first time period, (B) a comparison of frequencies of the collected data during the first time period, or (C) a comparison of a number of times for which the amplitude of the collected data. during the first time period exceeds a given threshold.

Additionally, or alternatively, in some cases, the expected profiles (acoustic wave/vibration/acoustic wave & vibration) can be compared to the corresponding actual profiles (acoustic wave/vibration/acoustic wave & vibration) from an end of the first time period until an end of the damping event, the end of the damping event occurring when amplitudes of the collected data remain below a second pre-defined value over a pre-defined time period (e.g., 20 milliseconds). The comparison between a respective expected profile and its corresponding actual profile can be at least one of a comparison of the resonance, damping and period values.

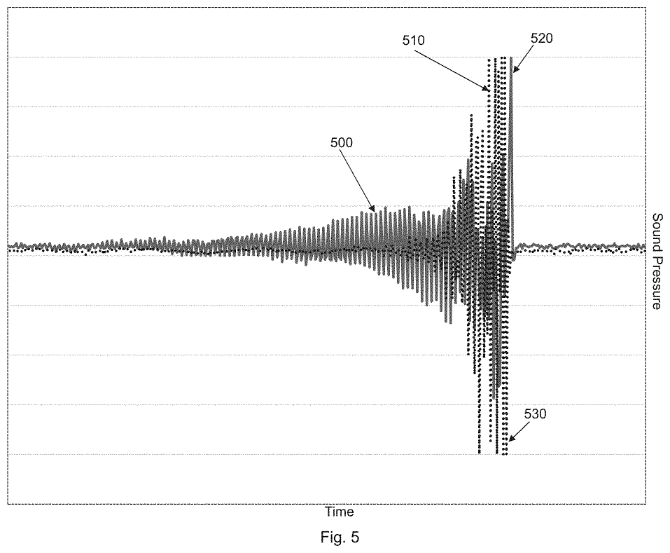

To explain this, attention is now drawn to FIG. 5, which provides: (i) a first graph that illustrates an example of a first acoustic wave profile 500 of an undamaged rigid structure 300, being both an expected acoustic wave profile and an actual acoustic wave profile of an undamaged rigid structure 300, and (ii) a second graph illustrating an example of a second acoustic wave profile 510 of a structurally damaged rigid structure, in accordance with the presently disclosed subject matter. It is to be noted that the first acoustic wave profile 500 and the second acoustic wave profile 510 begin on the right-hand side of the time axis and proceed leftward along the time axis. A peak amplitude 520 of the first acoustic wave profile 500 follows shortly (e.g., almost immediately) after the time at which the one-time impact is to be applied or is applied on the rigid structure 300. Likewise, a peak amplitude 530 of the second acoustic wave profile 510 follows shortly (e.g. almost immediately) after the time at which the one-time impact is applied on the rigid structure 300. It can be discerned from FIG. 5, for example, that the amplitude and frequency of the acoustic waves in the second acoustic wave profile 510 during the first time period following the impact event is greater than the amplitude and frequency of the acoustic waves in the first acoustic wave profile 500 during the first time period. Moreover, it can be discerned from FIG. 5, for example, that, during the damping event, the second acoustic wave profile 510 has a higher damping ratio than the first acoustic wave profile 500, such that the damping event for the second acoustic wave profile 510 ends earlier than the damping event for the first acoustic wave profile 500.

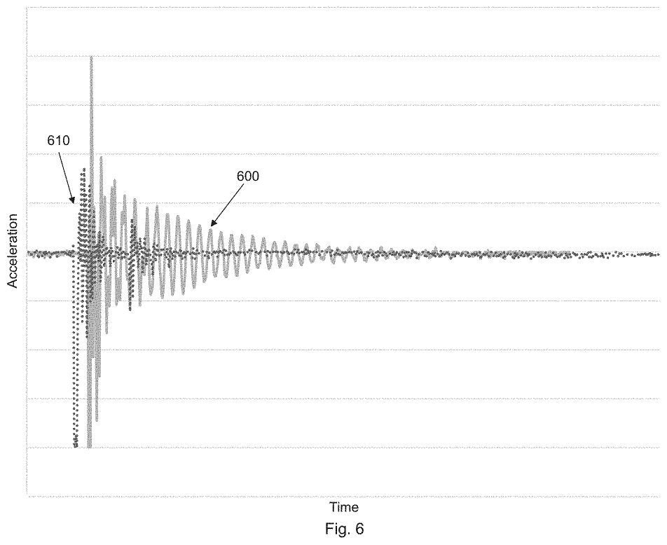

Attention is now drawn to FIG. 6, which provides: (i) a third graph that illustrates an example of a first vibration profile 600 of an undamaged rigid structure 300, being both an expected vibration profile and an actual vibration profile of an undamaged rigid structure 300, and (ii) a fourth graph that illustrates an example of a second vibration profile 610 of a structurally damaged rigid structure 300, in accordance with the presently disclosed subject matter. It is to be noted that the first vibration profile and the second vibration profile begin on the left-hand side of the time axis and proceed rightward along the time axis, It can be discerned from FIG. 6, for example, that a structurally damaged rigid structure 300 begins to experience observable vibrations during the first time period following the impact event earlier than an undamaged rigid structure 300. Moreover, it can be discerned from FIG. 6, for example, that, during the damping event, the first vibration profile 600 decays gradually and the second vibration profile 610 decays abruptly, such that the damping event for the second vibration profile 610 ends earlier than the damping event for the first vibration profile 600.

Returning to FIG. 4, processing circuitry 150 can be further configured, e.g. using structural damage detection module 160, to detect structural damage to the rigid structure 300 upon the compare indicating at least one of: (a) a first deviation above a first threshold between the expected acoustic wave profile and the actual acoustic wave profile or (b) a second deviation above a second threshold between the expected vibration profile and the actual vibration profile (block 432). In some cases, the rigid structure 300 is determined to be structurally damaged in the event that a probability that the rigid structure 300 is structurally damaged is greater than a given threshold.

Processing circuitry 150 can also be configured, upon detecting structural damage to the rigid structure 300, to provide a user of the system 100 with an indication that the rigid structure 300 is structurally damaged (block 436), e.g. via indication LEDs 250.

It is to be noted that, with reference to FIG. 4, some of the blocks can be integrated into a consolidated block or can be broken down to a few blocks and/or other blocks may be added. Furthermore, in some cases, the blocks can be performed in a different order than described herein. It is to be further noted that some of the blocks are optional. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for detecting structural damage to a rigid structure, the system comprising:
at least one impact generator capable of applying a one-time impact on the rigid structure, thereby causing the rigid structure to vibrate, wherein the impact generator has a known momentum upon an application of the one-time impact;
an acoustic sensor configured to measure acoustic waves radiated from the rigid structure;
a vibration sensor configured to measure vibrations of the rigid structure; and
a processing circuitry configured to:
obtain information defining (a) an expected acoustic wave profile of expected acoustic waves expected to radiate from the rigid structure, absent the structural damage to the rigid structure, in response to the application, by the impact generator, of the one-time impact on the rigid structure, and (b) an expected vibration profile of expected vibrations of the rigid structure, absent the structural damage to the rigid structure, in response to the application;
obtain actual acoustic waves radiating from the rigid structure, in response to the application, the actual acoustic waves being measured by the acoustic sensor;
generate an actual acoustic wave profile based on the actual acoustic waves;
obtain actual vibrations of the rigid structure, in response to the application, the actual vibrations being measured by the vibration sensor;
generate an actual vibration profile based on the actual vibrations;
compare (a) the expected acoustic wave profile with the actual acoustic wave profile and (b) the expected vibration profile with the actual vibration profile; and
provide a user of the system with an indication of the structural damage to the rigid structure upon the compare indicating at least one of: (a) a first deviation above a first threshold between the expected acoustic wave profile and the actual acoustic wave profile or (b) a second deviation above a second threshold between the expected vibration profile and the actual vibration profile.

2. The system of claim 1, wherein the one-time impact is applied by the impact generator on the rigid structure indirectly.

3. (canceled)

4. The system of claim 1, wherein the rigid structure is suspended in the air by a mechanical connection that is connected to the rigid structure upon the application of the one-time impact.

5. The system of claim 1, wherein the rigid structure is a ceramic plate.

6. The system of claim 5, wherein the ceramic plate includes one or more first layers made of polymeric material and one or more second layers made of ceramic material, wherein at least one given first layer of the first layers and an adjacent second layer of the second layers, adjacent to the given first layer, are affixed to each other.

7. The system of claim 6, wherein the structural damage is one or more of: a crack in one or more of the second layers, a fracture in one or more of the second layers, or a separation between the given first layer and the adjacent second layer.

8. The system of claim 1, wherein the expected acoustic waves are previously measured acoustic waves that were radiated from the rigid structure, in response to a first earlier application, by the impact generator, of the one-time impact on the rigid structure, absent the structural damage to the rigid structure.

9. The system of claim 1, wherein the expected vibrations are previously measured vibrations of the rigid structure, in response to a second earlier application, by the impact generator, of the one-time impact on the rigid structure, absent the structural damage to the rigid structure.

10. (canceled)

11. (canceled)

12. (canceled)

13. The system of claim 1, wherein the impact generator includes a spring-loaded mechanical element, and wherein the one-time impact is applied by pulling the mechanical element.

14. The system of claim 13, wherein the acoustic sensor, the vibration sensor and the processing circuitry are activated in response to the pulling of the mechanical element.

15. A method for detecting structural damage to a rigid structure, the method comprising:
obtaining information defining an expected acoustic wave profile of expected acoustic waves expected to radiate from the rigid structure, absent the structural damage to the rigid structure, in response to an application, by an impact generator, of a one-time impact on the rigid structure that causes the rigid structure to vibrate, wherein the impact generator has a known momentum upon the application of the one-time impact;
obtaining information defining an expected vibration profile of expected vibrations of the rigid structure, absent the structural damage to the rigid structure, in response to the application;
obtaining actual acoustic waves radiating from the rigid structure, in response to the application, the actual acoustic waves being measured by an acoustic sensor;
generating an actual acoustic wave profile based on the actual acoustic waves;
obtaining actual vibrations of the rigid structure, in response to the application, the actual vibrations being measured by a vibration sensor;
generating an actual vibration profile based on the actual vibrations;
comparing (a) the expected acoustic wave profile with the actual acoustic wave profile and (b) the expected vibration profile with the actual vibration profile; and
providing an indication of the structural damage to the rigid structure upon the comparing indicating at least one of: (a) a first deviation above a first threshold between the expected acoustic wave profile and the actual acoustic wave profile or (b) a second deviation above a second threshold between the expected vibration profile and the actual vibration profile.

16. The method of claim 15, wherein the one-time impact is applied by the impact generator on the rigid structure indirectly.

17. (canceled)

18. (canceled)

19. The method of claim 15, wherein the rigid structure is a ceramic plate.

20. The method of claim 19, wherein the ceramic plate includes one or more first layers made of polymeric material and one or more second layers made of ceramic material, wherein at least one given first layer of the first layers and an adjacent second layer of the second layers, adjacent to the given first layer, are affixed to each other.

21. (canceled)

22. The method of claim 15, wherein the expected acoustic waves are previously measured acoustic waves that were radiated from the rigid structure, in response to a first earlier application, by the impact generator, of the one-time impact on the rigid structure, absent the structural damage to the rigid structure.

23. The method of claim 15, wherein the expected vibrations are previously measured vibrations of the rigid structure, in response to a second earlier application, by the impact generator, of the one-time impact on the rigid structure, absent the structural damage to the rigid structure.

24. The method of claim 15, wherein the actual acoustic waves and the actual vibrations are measured simultaneously.

25. (canceled)

26. (canceled)

27. The method of claim 15, wherein the impact generator includes a spring-loaded mechanical element, and wherein the one-time impact is applied by pulling the mechanical element.

28. The method of claim 27, wherein the acoustic sensor, the vibration sensor and the processing circuitry are activated in response to the pulling of the mechanical element.

29. A non-transitory computer readable storage medium having computer readable program code embodied therewith, the computer readable program code, executable by a processing circuitry of a computer to perform a method for detecting structural damage to a rigid structure, the method comprising:
obtaining information defining an expected acoustic wave profile of expected acoustic waves expected to radiate from the rigid structure, absent the structural damage to the rigid structure, in response to an application, by an impact generator, of a one-time impact on the rigid structure that causes the rigid structure to vibrate, wherein the impact generator has a known momentum upon the application of the one-time impact;
obtaining information defining an expected vibration profile of expected vibrations of the rigid structure, absent the structural damage to the rigid structure, in response to the application;
obtaining actual acoustic waves radiating from the rigid structure, in response to the application, the actual acoustic waves being measured by an acoustic sensor;
generating an actual acoustic wave profile based on the actual acoustic waves;
obtaining actual vibrations of the rigid structure, in response to the application, the actual vibrations being measured by a vibration sensor;
generating an actual vibration profile based on the actual vibrations;
comparing (a) the expected acoustic wave profile with the actual acoustic wave profile and (b) the expected vibration profile with the actual vibration profile; and
providing an indication of the structural damage to the rigid structure upon the comparing indicating at least one of: (a) a first deviation above a first threshold between the expected acoustic wave profile and the actual acoustic wave profile or (b) a second deviation above a second threshold between the expected vibration profile and the actual vibration profile.
